(19) United States
(12) Patent Application Publication
(10) Pub. No.: US 2014/0009942 A1
(43) Pub. Date: Jan. 9, 2014

(54) LED STRIP LAMP AND REFLECTOR THEREFOR

(71) Applicant: Michael KRAMER, Kamp-Lintfort (DE)

(72) Inventor: Michael KRAMER, Kamp-Lintfort (DE)

(21) Appl. No.: 13/932,125

(22) Filed: Jul. 1, 2013

(30) Foreign Application Priority Data
Jul. 6, 2012 (DE) 102012013332.4

(51) Int. Cl. F21V 7/09; F21V 7/20

(52) U.S. Cl. CPC F21V 7/09; F21V 7/20
USPC 362/296.07; 362/347; 362/345

(57) ABSTRACT

A reflector for a strip-type LED lamp. The reflector is generally of U-section, longitudinally elongated, and formed by a longitudinally extending floor formed with a plurality of holes adapted to be aligned with respective LEDs of the lamp, and a pair of longitudinally extending side walls projecting transversely from outer edges of the floor and diverging away from the floor. The side walls have respective outer edges deflectable elastically transversely toward each other.

### FIELD OF THE INVENTION

The present invention relates to a light-emitting-diode (LED) strip lamp. More particularly this invention concerns a reflector for such a lamp.

### BACKGROUND OF THE INVENTION

A typical LED lamp reflector, in particular, for a lamp using LEDs as a light source, the LEDs being arrayed in a row along a longitudinal axis of the reflector. A lamp comprising an adapter profile holding the light sources, in particular, LED strips, has a floor web inside the adapter profile on which light sources, in particular, LEDs disposed in line in an axis of longitudinal extent, are disposed between mutually opposing or side brackets walls and opposite an opening created by the top edges of the walls. The interior of the adapter profile widens outwardly from the floor web toward the opening, and the mutually opposing side brackets at the end close to the opening each include at least one inwardly directed projection that the entire length of the adapter profile.

LED lamp reflectors are in general well-known in the art, and are used, for example, in order to shape the light dispersion characteristics in LED lamps, that is, those lamps in which the light sources are composed of LEDs, in particular, due to the fact that the aperture angle of the light cone emitted by LEDs is frequently very large. Thus beam-shaping reflectors can be employed whenever smaller light cones or in general light dispersion characteristics are desired that are different from those originally provided by a LED.

Also known in the art are arrangements of LEDs in which the individual LEDs are mounted on a rigid circuit board, or also very often a flexible circuit board successively in line in an axis of longitudinal extent.

These LED strips or rows are frequently employed as a prefigured component in lamps, with each individual LED provided with its own separate reflector body in order to create the light dispersion characteristics of each individual LED based on the prior art, to which end this reflector surrounds the LED and is optionally intended to be attached to the rigid or also flexible circuit board. Special reflector holders, for example, can be provided for this attachment, which holders are attached to the circuit board surrounding the LED so as to hold this type of reflector.

Lamps having these LED strips or LED rows, and the currently known individual reflector arrangements are obviously expensive and require multiple, sometimes identical manipulation steps when produced, since sometimes tens or hundreds of LEDs have to be fitted with reflectors for an individual LED strip or LED row within a lamp comprising this type of LED strip or LED row.

### OBJECTS OF THE INVENTION

It is therefore an object of the present invention to provide an improved LED lamp reflector.

Another object is the provision of such an improved LED lamp reflector that overcomes the above-given disadvantages, in particular that is easy to handle and inexpensive to produce, in particular, in combination with lamps that employ light sources, in particular, LED rows or LED strips that are oriented in a longitudinally extending row.

An especially preferred object of the invention is also to develop a lamp of the above-referenced type by means of an LED lamp reflector that achieves the above-mentioned object, which type of lamp has been disclosed, for example, in US 2013/0039052.

### SUMMARY OF THE INVENTION

A reflector for a strip-type LED lamp. The reflector is generally of U-section, longitudinally elongated, and formed by a longitudinally extending floor formed with a plurality of holes adapted to be aligned with respective LEDs of the lamp, and a pair of longitudinally extending side walls projecting transversely from outer edges of the floor and diverging away from the floor. The side walls have respective outer edges deflectable elastically transversely toward each other. Here “diverge” means that the distance between the side walls relative to each other increases from the floor upward. As defined by the invention, directional information is with reference to the emitted light pattern that is assumed to be upward.

The advantage of this type of LED lamp reflector is that due to its length measured longitudinally the reflector is formed with a longitudinal row of holes corresponding to a specific repeating dimension, in other words, according to the invention a single LED lamp reflector can be used simultaneously for a plurality of multiple LEDs, and this aspect offers advantages, in particular, when multiple LEDs are used in one lamp, as mentioned above, that are also disposed successively in line in an axis of longitudinal extent with equidistant spacing relative to each other. An LED lamp reflector of this type can thus be used especially advantageously with the referenced LED rows or LED strips. The invention thus eliminates the need to fit each individual LED of this lamp with an individual, separate and dedicated reflector. Instead this approach provides the ability to use a single or only a few U-section LED lamp reflectors according to the invention that functions simultaneously as the reflector for multiple, preferably, all of the LEDs of this lamp.

According to the invention, a lamp can have the described LED lamp reflector that includes the type of features referenced above, which furthermore comprises this type of U-section LED lamp reflector in its adapter profile. Provision can then be made according to the invention whereby this lamp reflector is mounted in the adapter profile by an effective clamping connection between the projections and the elastic top edges of the LED lamp reflector.

This type of mount is advantageously achieved here according to the invention by also making the interior of the adapter profile widen toward the opening—as is also the case for the lamp reflector due to the diverging side walls—which aspect has the result that after insertion in a lamp having this above-described adapter profile this lamp reflector according to the invention with side walls moved toward each other against the elastic force tends to press apart the top edges of the diverging side walls due to the elastic force, that is, to increase the distance between the edges, with the result that a force is exerted on the interior of the adapter profile which, as described, is in turn designed so as to widen toward the opening. This creates an effective force component in the direction of the opening that shifts the reflector according to the invention out automatically toward the opening, that is, essentially out of the interior of the adapter profile, until the top edges of the diverging side walls of this inventive reflector strike the projections at the outer edges of the opposite walls of the adapter profile, and are locked there in place. This perfectly positions the reflector in the adapter profile.

An LED lamp reflector according to the invention and a lamp according to the invention of above-mentioned type in combination with this type of lamp reflector thus together have the special advantage of not requiring any special mounting means to mount the LED lamp reflector in the lamp according to the invention.

Instead, all that is required is simply to press an LED lamp reflector according to the invention from above into the interior of the adapter profile, to which end the diverging side walls, in particular, their outer edges when inserted contact the above-mentioned projections, the diverging side walls are moved toward each other by the projections, and, after passing the projections, the distance between the diverging side walls, or their top edges, increases again behind the projections in the insertion direction, and, as a result, the projections grip behind the projections in the insertion direction.

Another advantageous aspect here is that a reflector of this described type in combination with a lamp of the described type is fundamentally able to be displaced longitudinally, thereby enabling an orientation of the individual holes in the reflector relative to the LEDs, or also other electronic components, to be performed fairly easily, without the need to release other fasteners. Another advantageous aspect is that all of the holes within an LED lamp reflector according to the invention are optimally positioned relative to each other and to the corresponding LEDs, or also relative to other electronic components. It is also advantageous that this type of reflector can easily be shortened.

In one possible embodiment of an LED lamp reflector, provision can be made whereby the two above-referenced side walls are symmetrical relative to each other. This symmetry is specifically understood to be relative to a center plane that is oriented parallel to the axis of longitudinal extent and centrally relative to the holes, in particular, perpendicular to the floor, such that mirror symmetry can exist in terms of this center plane.

This embodiment has the advantage that the emitted light cone of a corresponding lamp having this type of LED lamp reflector is essentially equivalent to a row of lamps whose aperture angle is also symmetrical around the light sources that are disposed successively in line in the axis of longitudinal extent and are provided by the LEDs.

In order to be able to shape the light dispersion characteristics, in particular, the aperture angle, as desired and so as to meet requirements, a development of this embodiment can provide an approach whereby one top region respectively of each side wall is bent outward. This bending can be implemented, for example, by having the bent outer edge lie in a plane that is parallel to the floor. When this reflector is viewed from above, the result is a light emission slot that is more or less tapered relative to the maximum possible width, depending on the width of any edge flange.

One development, by way of example, can provide an approach whereby an edge flange of each side wall is of a width that is perpendicular to the axis of longitudinal extent, where this corresponds to between 15% and 40%, preferably, 20% and 30% of the height of the edge flange above floor. By way of example, the embodiment can be such that the sum of the widths of the two edge flanges of both side walls corresponds to the width of the floor.

This embodiment, or other embodiments as well, can provide an approach whereby the side walls of the LED lamp reflector that extend between the floor and the top edge flange are completely out of contact with inner faces of a lamp of the above-described type. Contact between reflector and lamp, or its adapter profile, is only at the outer edges of the reflector.

However, another embodiment can provide an approach whereby the side walls—at least in certain regions, preferably, across the entire length and entire height of each side wall above the floor—have an external shape that is matched to the inner shape of a U-section adapter profile of a lamp in which the

LED lamp reflector can be inserted. After insertion, what results is not only a non-positive engagement of the above-described type but also simultaneously a positive-locking engagement between the exterior of the diverging side walls of the LED lamp reflector and the interior of the adapter profile, due to the fact that the above-referenced parts fit complementarily with each other. This approach first of all further stabilizes the position of the LED lamp reflector in a lamp, and secondly it also enables the reflector to have an improved heat-conducting thermal connection to the adapter profile due to an enlarged contact area between LED lamp reflector and the adapter profile, and thus allows the reflector to perform additional cooling functions aside from its reflective functions.

Matching the exterior of the diverging side walls of the LED lamp reflector and the interior of the above-referenced U-section adapter profile of a lamp can be effected such that the shapes of both components in terms of cross-section perpendicular to the axis of longitudinal extent are at least partially, preferably, completely identical relative to the height of the side walls of the LED lamp reflector above the floor.

Another embodiment provides an approach whereby both side walls of the LED lamp reflector according to the invention are asymmetrical relative to each other. This asymmetry can be provided, for example, relative to a center line parallel to the axis of longitudinal extent and centrally relative to the holes in the floor, in particular, relative to a center plane that is oriented perpendicular to the floor.

This asymmetry provides the advantage that the light emission pattern can also be shaped asymmetrically relative to a line in which the individual LEDs are disposed in a line as light sources. This thus provides the ability, for example, to position lamps according to the invention symmetrically in a space, and to generate deviating light patterns independently of this object symmetry thus created.

According to the invention, asymmetries can also be created between the two side walls of the LED lamp reflector according to the invention by various design approaches that can also be combined with each other. For example, provision can be made whereby one of the side walls relative to the above-referenced center plane is at a smaller distance perpendicular to the axis of longitudinal extent than the other side wall. Similarly, one of the side walls relative to the floor can assume an angle that is different from the other side wall, or can have a different curvature or different radius of curvature cross-sectionally perpendicular to the axis of longitudinal extent when the side walls are curved. This can mean that the centers of each curvature have different distances relative to the above-referenced center plane. Provision can also be made whereby only one of the two side walls is bent outward at an outer edge about a bend line that lies in the axis of longitudinal extent. This bend can be effected, as in the above-described embodiment, by having the edge flange lie in a plane parallel to the floor, or by having the two edge flanges coplanar.

A development can be combined with all of the above-referenced different embodiments whereby the holes provided in the floor in the axis of longitudinal extent have alternating different shapes, in particular, whereby holes of round and rectangular cross-section alternate with one another.

In addition to the original visual appearance of this lamp reflector, this approach can achieve the result whereby the holes of a first shape—for example, those of rectangular cross-section—are each associated with a LED, in particular, surround this LED, while the holes of a second shape—in particular, those of round cross-section—are each associated with, for example another electronic component, in particular, surround this other electronic component.

In this way, the light emergence aperture for the holes surrounding LEDs can first be defined by the hole of one shape, for example, rectangular shape, while the other hole can be provided to improve the cooling either of a component that is disposed in the hole or of components disposed below the reflector. This component can be, for example, a constant current source that can be associated with a given LED.

It is obviously also possible to provide all of the holes in the floor of an LED lamp reflector according to the invention with identical shape, wherein provision can also be made analogously to the above embodiment in a design of identical shape whereby one LED is surrounded by a first hole following is successively in a line, and an electronic component, for example, a component to be cooled, is surrounded following a subsequent hole.

Another embodiment provides an approach whereby holes are provided only so as to create light emergence apertures for the LED that is surrounded by a hole or is covered by the hole, and to form their light dispersion characteristics.

Regardless of whether only round holes are present in a LED lamp reflector according to the invention, or, on the other hand, alternating holes of different shapes, of which at least one is a round shape are present, provision can be made whereby holes having this round cross-section are designed such that these each have a wall that is located below the floor and surrounds a respective center axis of the hole (perpendicular to the axis of longitudinal extent, and in particular, perpendicular to the floor), wherein provision can be made, for example, whereby this wall surrounding the center axis of the hole is flared downward from the plane of the floor, for example, by using a molding process such as deep-drawing.

In a development of this embodiment, provision can be made whereby each wall that is located below the floor and surrounds a respective center axis of the hole is provided in rotationally-symmetrical form about this center axis of the hole, in particular, is dome-shaped.

Regardless of the above-referenced embodiments within a lamp according to the invention, the configuration of a lamp reflector according to the invention can be such that the plane of the floor within which a given hole is provided, after installation within a lamp according to the invention, is disposed in the plane of the surface of an LED, or even thereunder, in other words, the assumed idealized point-type light source of an LED lies inside the hole, or even passes slightly through this hole into the interior of the U-section reflector, or such that the floor of a lamp reflector according to the invention after installation is located in a lamp above an LED of the lamp, preferably even such that in an embodiment, which has a wall located below the floor and surrounding the hole axis, a bottom edge of this wall is disposed above the LED.

In a development that is possible for all of the embodiments, supplemental provision can be made whereby the interior of the adapter profile of a lamp according to the invention is cast using an at least translucent, preferably, transparent potting compound. This type of encapsulation can, for example be effected up to or beyond the above-referenced projections, or even up to the top edge of the adapter profile. In this embodiment, an especially preferred approach is for the LED lamp reflector to be embedded in the encapsulation compound, thus, in particular, completely enclosed by the encapsulation compound.

An encapsulated embodiment provides the advantage that a lamp according to the invention can meet the requirements for high IP protection class, for example IP68. The encapsulation compound can be composed of a transparent polyurethane foam. In a further preferred embodiment, the encapsulation can be effected in such a way that the surface of the encapsulation compound in the solidified state has a an outward-facing curvature, in other words, is outwardly convex.

### BRIEF DESCRIPTION OF THE DRAWING

The above and other objects, features, and advantages will become more readily apparent from the following description, reference being made to the accompanying drawing in which:

FIG. 1 is a perspective small-scale view of a first embodiment of the lamp according to the invention;

FIG. 2 is a cross section taken along line II-II of FIG. 3;

FIG. 3 is a top view of the FIG. 1 lamp;

FIG. 4 is a side view of the FIG. 1 lamp;

FIG. 5 is a perspective small-scale view of a second embodiment of the lamp according to the invention;

FIG. 6 is a cross section taken along line VI-VI of FIG. 7;

FIG. 7 is a top view of the FIG. 5 lamp;

FIG. 8 is a side view of the FIG. 5 lamp;

FIG. 9 is a perspective small-scale view of a third embodiment of the lamp according to the invention;

FIG. 10 is a cross section taken along line X-X of FIG. 11;

FIG. 11 is a top view of the FIG. 9 lamp; and

FIG. 12 is a side view of the FIG. 9 lamp.

### DETAILED DESCRIPTION OF THE INVENTION

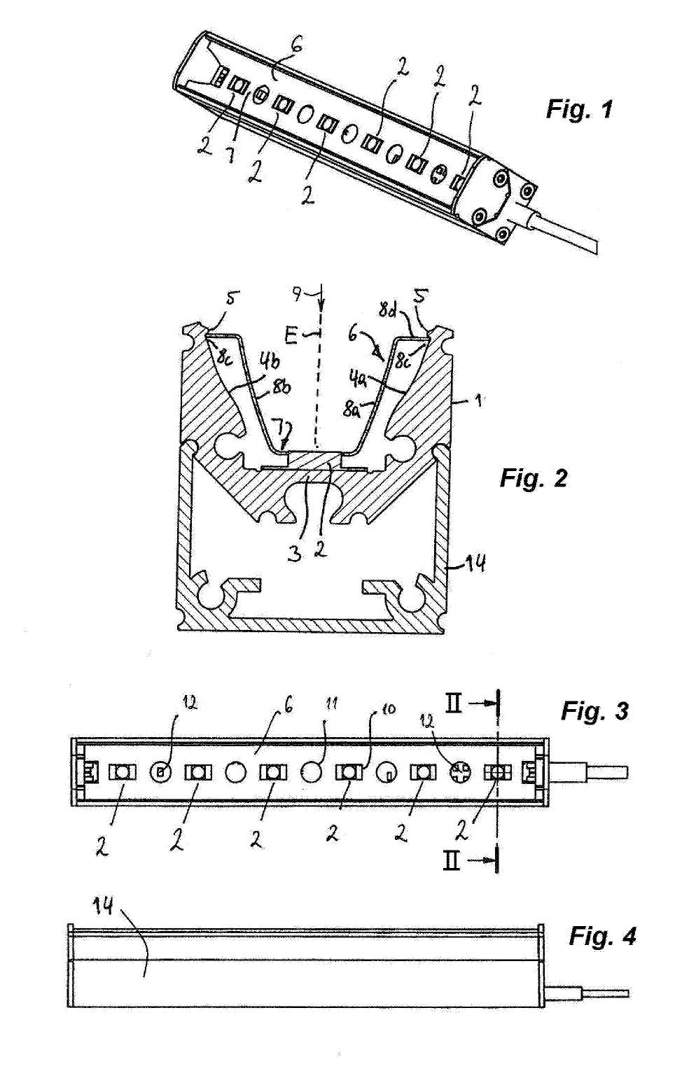

As seen in FIGS. 1-4 an LED strip lamp according to the invention is similar to that in US 2013/0039052, which is herewith incorporated by reference. This lamp includes a U-section adapter profile 1 for a light source, such as, for example, a strip of LEDs 2 that are disposed in a straight row at a uniform spacing along a longitudinal axis here perpendicular to the view plane of FIG. 2. Thus only one LED 2 is seen in the cross section of FIG. 2, but several are seen in FIGS. 2 and 3. The profile 1 can sit in a number of different orientations in a mounting rail 14.

These LEDs 2 are mounted on a floor web 3 of the adapter profile. This adapter profile 3 has longitudinally extending and transversely spaced side brackets 4a and 4b that flare apart away from the floor web 3 to form an opening between outer edges of these opposing walls 4a and 4b.

Each of the walls 4a and 4b is formed near its outer end with an inwardly projecting ridge formation 5 that slightly reduces the maximum transverse spacing at the outer side of the profile 1, forming an undercut opening. The ridges 5 can be longitudinally continuous or formed by a longitudinal row of longitudinally spaced bumps or short ridges.

In the first embodiment shown in FIGS. 1-4 a reflector 6 according to the invention is provided. It is also basically of U-section, made of sheet metal, and extends longitudinally generally the whole length of the adapter 1. The reflector 5 has a basically planar floor 7 and a pair of side walls 8a and 8b. The floor 7 is formed with rectangular holes 10 alternating with round holes 11 in a straight line down the center, here six holes 10 and five holes 11. The sheet metal of the reflector 6 allows the walls 8a and 8b to be deflected elastically transversely toward and away from each other perpendicular to a center symmetry plane E of the reflector 6. These side walls 8a end at planar flanges 8d that are coplanar and perpendicular to the symmetry plane E and that form outer edges 8c of the side walls 8a and 8b.

It is therefore possible to insert an LED lamp reflector according to the invention into the opening of the adapter profile 1 in the direction of arrow 9, so that the initially diverging side walls, or their top edges, are pressed elastically toward each other against the effective elastic force due to the interaction between projections 5 and the edges 8c of the side walls 8a and 8b. After passing the projections 5 in the insertion direction 9, the distance between the edges 4c is increased by the elasticity of the reflector 6 and these edges thus click into place behind the projections 5.

At the same time, the outwardly directed force that is exerted by the edges 8c of the reflector 6 on diverging side brackets 4a and 4b is effective as a force component opposite to the insertion direction of arrow 9, with the result that the reflector 6 according to the invention is automatically secured in this position by this force.

Also revealed in FIG. 1, in particular, in the perspective view and in the top view, is the fact that the rectangular holes 10 of the reflector 6 surround respective LEDs 2. The circular holes 11 forming open for cooling of electrical components such as power-supply elements as indicated at 12.

In addition to the attractive appearance shown in FIG. 1 that is conspicuous due to the alternating different cross-sectional shapes, the invention thus also provides the ability to have a positive effect on the cooling of the electronic components of an LED strip or LED row—in contrast to conventional reflectors that are designed only to shape the emitted light beam.

FIG. 1 furthermore shows, in particular, in the cross-section view, that the side walls of the LED lamp reflector 8a and 8b are provided here in mirror-symmetrical form relative to the plane E extending perpendicular to the view plane of FIG. 2 and to the floor web 3 of the adapter profile 1 and to the floor 7 of the reflector 6.

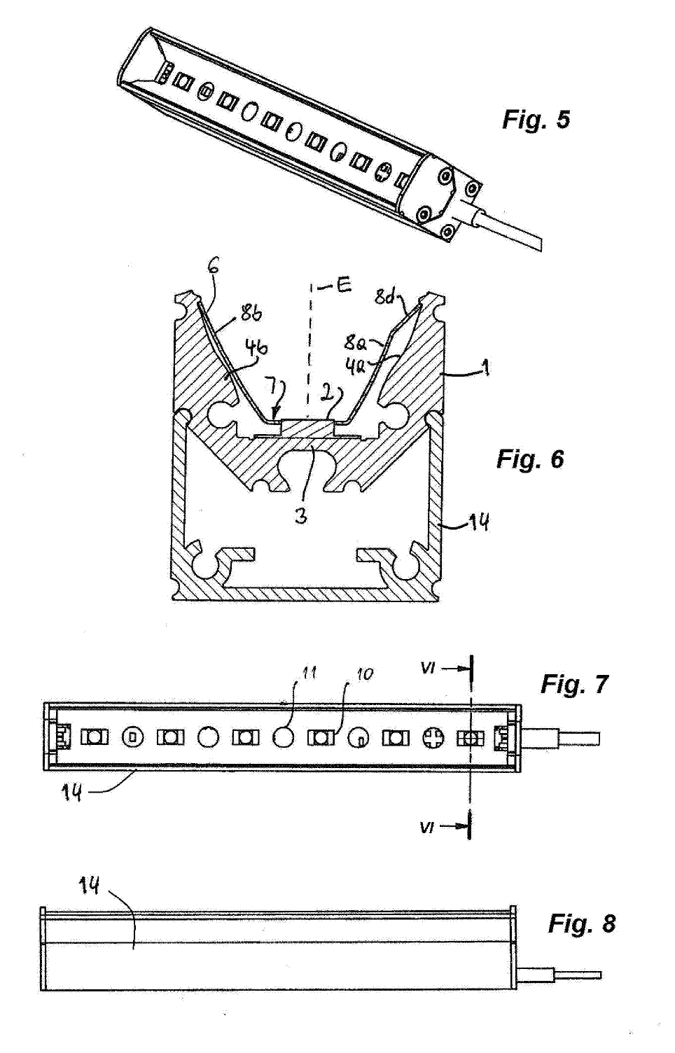

In contrast to the above, FIGS. 5-8 show a modified embodiment in which side walls 8b and 8a of the LED lamp reflector are shaped asymmetrically relative to the same plane E. In this case, the asymmetry is created, for example, by the fact that one of side walls 8a is bent outward about a bend line in a top region 8d. This produces asymmetrical light dispersion characteristics relative to the idealized assumed point-type light sources of the LEDs, whereby in this case the created light emission pattern is shifted in the direction above indicated plane E relative to its intensity maximum due to the fact that side wall 8a shown in FIG. 2 encloses an angle relative to the plane that is smaller than side wall 8b.

FIGS. 5-8 show that the top flange 8d of the side wall 8a lies in a plane that intersects the plane in which floor 7 of the reflector is disposed and is not coplanar with the rest of the side wall 8a. This is unlike the system of FIGS. 1-4 in which the top flanges 8d are in a plane parallel to the plane of floor 7. In particular, this enables the opening width of the reflector between side walls 8a and 8b to be adjusted based on the width defined between the outer edges 8c of the top flange or flanges 8d.

In FIGS. 5-8 the holes 10 and 11 like those of FIGS. 1-4 in the floor 7 of the reflector 6 can have different shapes.

In this regard, the embodiment of both FIGS. 1-4 and also FIGS. 5-8 are such that floor 7, which includes the holes in the plane of the component surface or is slightly below the component surface of LED 2, that is, so that LED 2 at least occupies hole 10 associated with it, passes in some cases by its top surface through the hole into the interior of the U-section reflector.

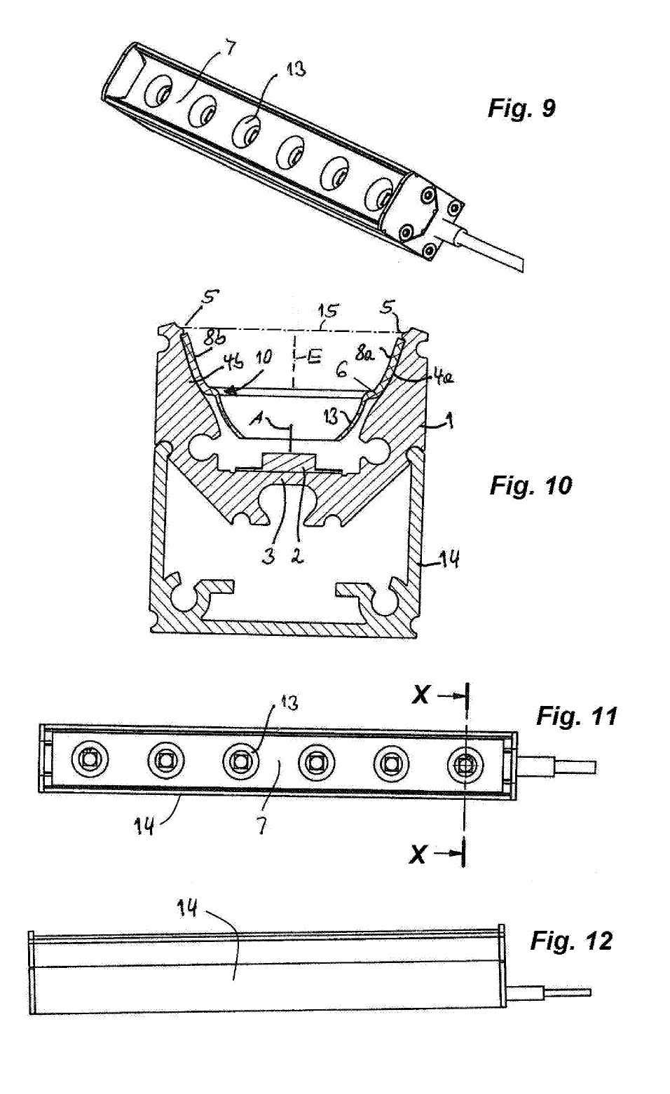

In contrast to the above-described embodiments, FIGS. 9-12 show a lamp that comprises essentially exactly the same features as in FIGS. 1-8, and also a reflector 6 of an inventive symmetrical design about the above-referenced plane E. Here side walls 8a and 8b of the U-section LED lamp reflector not only grip behind respective projections 5 of the adapter profile by their outer edges 8c, but where at the same time the outer faces of these side walls 8a and 8b conforms to the somewhat concave shape of the inner faces of the side brackets 4a and 4b of the adapter profile 1 that widen out toward the opening, thereby resulting in a positive locking engagement that creates a large contact area between adapter profile and reflector such that the reflector 6 here can also be utilized to dissipate heat into the adapter profile 1.

The plane of the floor 7 of the reflector according to the invention in this embodiment is disposed considerably above the surface of LED 2. R a rotationally symmetrical annular walls 13 are formed around a center axis a of each such LED 2. The lower edge of this annular wall 13 is spaced above the LED 2. In this embodiment indicated in FIG. 3, this wall 13, which surrounds axis A in rotationally-symmetrical fashion, is dome-shaped and has a circular opening.

The embodiment of FIGS. 9-12 has only holes 10 in the planar floor 7 that are each associated with a LED 2, that is a respective LED and surrounding its optical beam emission axis.

Irrespective of the various design embodiments of the lamp reflectors according to the invention and their associated visual appearance, all of the embodiments have the advantage essential to the invention that they can be can be mounted in a lamp of the described type by a snap-in process and resulting clamping action between top edges 8c and projections 5, without requiring additional mounting means to accomplish this, such as a screw-type connection, adhesive attachment, or of another type.

FIG. 10 also shows at 15 a line to which the adapter profile 1 is filled with a translucent potting mass that wholly embeds the reflector 6, here made of plastic with a mirrored interior.

I claim:

1. A reflector for a strip-type LED lamp, the reflector being generally of U-section, longitudinally elongated, and formed by:
a longitudinally extending floor formed with a plurality of holes adapted to be aligned with respective LEDs of the lamp; and
a pair of longitudinally extending side walls projecting transversely from outer edges of the floor and diverging away from the floor, the side walls having respective outer edges deflectable elastically transversely toward each other.

2. The LED lamp reflector defined in claim 1, wherein the reflector is symmetrical to a longitudinally extending plane bisecting the floor and between the side walls.

3. The LED lamp reflector defined in claim 1, wherein at least one of the side walls is formed with an outwardly bent planar edge flange forming the respective outer edge.

4. The LED lamp reflector defined in claim 3, wherein the edge flange has a transverse dimension equal to 15% to 40% of the transverse spacing of the edge flange from the floor.

5. The LED lamp reflector defined in claim 4 wherein the dimension is equal to 20% to 30% of the transverse spacing of the edge flange from the floor.

6. The LED lamp reflector defined in claim 3, wherein only one of the side walls is formed with the outwardly bent planar edge flange.

7. The LED lamp reflector defined in claim 6, wherein the one side wall is complementarily shaped to an inner face of a side bracket of the light fixture between the respective flange and the floor.

9. The LED lamp reflector defined in claim 3, wherein each of the side walls is formed with an outwardly bent planar edge flange forming the respective outer edge.

10. The LED lamp reflector defined in claim 9, wherein both of the edge flanges are coplanar and the reflector is symmetrical to a longitudinally extending symmetry plane bisecting the floor and perpendicular to the edge flanges.

11. The LED lamp reflector defined in claim 1, wherein the floor is formed with a longitudinally extending row of holes at least some of which are oriented to align with respective LEDs of the lamp.

12. The LED lamp reflector defined in claim 11, wherein some of the holes are oriented to align with respective heat-generating parts of the lamp to cool same.

13. The LED lamp reflector defined in claim 11 wherein the holes are of different shapes.

14. The LED lamp reflector defined in claim 1, wherein the reflector is asymmetrical with respect to a longitudinally extending plane bisecting the floor.

15. The LED lamp reflector defined in claim 14, wherein the reflector is asymmetrical because of at least one of the following conditions:
one of the side walls is closer to the symmetry plane than the other,
one of the side walls extends from the floor at an angle different from an angle between the other side wall and the floor,
one of the side walls is curved differently from the other side wall, and
only one of the side walls is formed with an outwardly bent planar edge flange not parallel to the rest of the one side.

16. The LED lamp reflector defined in claim 1 wherein the floor is formed centered on respective axes perpendicular to the floor with respective downwardly projecting axially symmetrical collars.

17. In combination with the LED lamp reflector defined in claim 1,
a generally U-section adapter profile having a longitudinally extending floor web and a pair of side brackets extending outward from outer edges of the floor and flaring away from the floor, each side edge having at an outer edge an inwardly projecting ridge formation, the reflector being fittable in the profile with the outer edges engaged under the ridges and bearing elastically outward on inner faces of the side brackets.

18. The combination defined in claim 17, wherein the floor web of the profile is provided with a row of LEDs and heat-generating circuit elements, the floor of the reflector being formed with throughgoing holes oriented to align with the LEDs and elements.

19. The combination defined in claim 18 wherein the holes alignable with the LEDs are of circular shape and the holes alignable with the elements are rectangular.

20. The combination defined in claim 17, further comprising:
a mass of translucent potting filling the profile between the side brackets and wholly covering the reflector.
